(19) United States
(12) Patent Application Publication
(10) Pub. No.: US 2012/0222651 A1
(43) Pub. Date: Sep. 6, 2012

(54) Backwards Injected Engine

(76) Inventor: Francis Xavier Gentile, Los Angeles, CA (US)

(21) Appl. No.: 13/371,498

(22) Filed: Feb. 13, 2012

Related U.S. Application Data
(63) Continuation-in-part of application No. 12/903,286, filed on Oct. 13, 2010.
Application No. 12/903,286 is a continuation-in-part of application No. 12/758,873, filed on Apr. 13, 2010, now Pat. No. 8,104,450.
(60) Provisional application No. 61/442,268, filed on Feb. 13, 2011.

(51) Int. Cl. F02D 9/04; F02D 19/12; F02D 41/04; F02D 13/02

(52) U.S. Cl. 123/347

(57) ABSTRACT

Fuel is injected into and through the exhaust port and into the cylinder of the piston engine during the time when the flow is reversed from the normally expected flow. The engine is able to operate with some or all of its fuel injected backwards of conventional expectations. In another embodiment the fuel is injected with solid stream injector sprays directed against exhaust valves and ports and deflected into the piston cylinder against the flow of normally aspirated or supercharged engines. This invention can apply to gasoline or diesel cycles and four and two stroke type cycles of engine.

### CROSS REFERENCE TO RELATED APPLICATIONS

This application is a CIP continuation in part of Ser. No. 13/355,572 filed 23 Jan. 2012 which is a continuation of Ser. No. 12/758,873 filed 2010 Apr. 13 which was based on PPA Ser. No. 61/168,625 filed 2009 Apr. 13. This application is also a CIP of CIP U.S. Ser. No. 12/903,286 filed 13 Oct. 2010 which is a CIP of Ser. No. 12/758,873 filed 2010 Apr. 13. This application claims the benefit of PPA Ser. Nr 61/442,268 filed 13 Feb. 2011 by the present Inventor, which is incorporated by reference.

Disclosed as related applications and Integrated into this disclosure by specific reference to previous applications by the same inventor are:
13 Apr. 2010 Ser. No. 12/758,873 USPTO Granted U.S. Pat. No. 8,104,450 B2
14 Apr. 2010 PCT/US10/30957 US published as WO 2010/120831 A1
13 Oct. 2010 U.S. Ser. No. 12/903,286
13 Oct. 2010 PCT/US10/52422 published as WO 2011/129846 A1
23 Jan. 2012 U.S. Ser. No. 13/355,572 utility

### BRIEF DESCRIPTION OF THE SEVERAL VIEWS OF THE DRAWINGS

### Figures

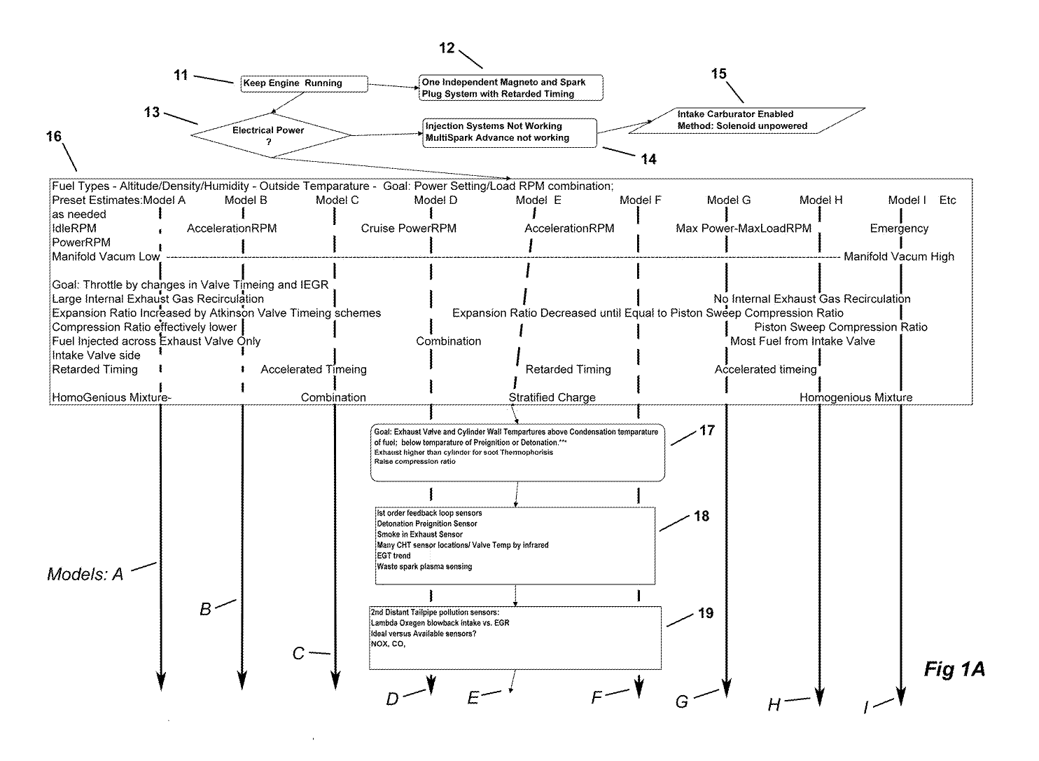

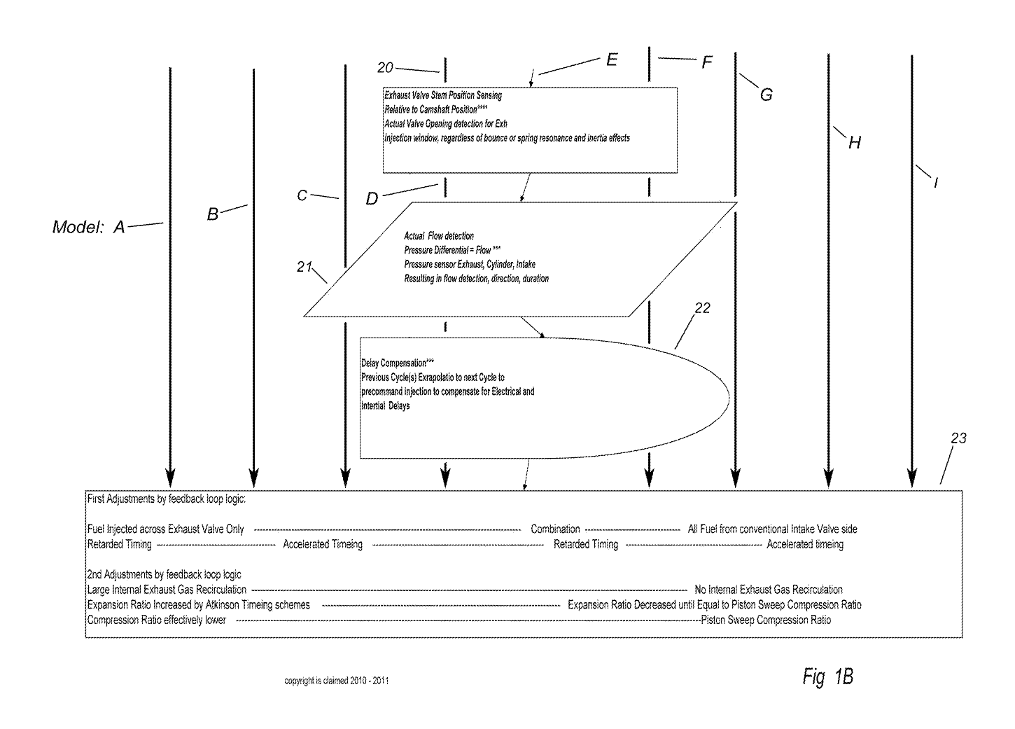

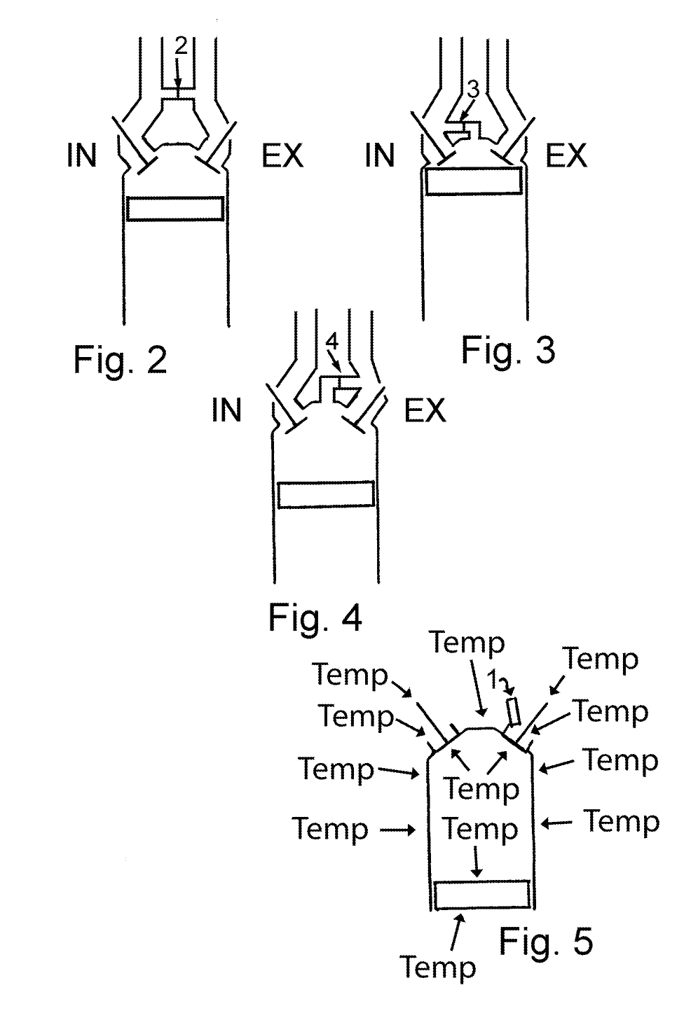

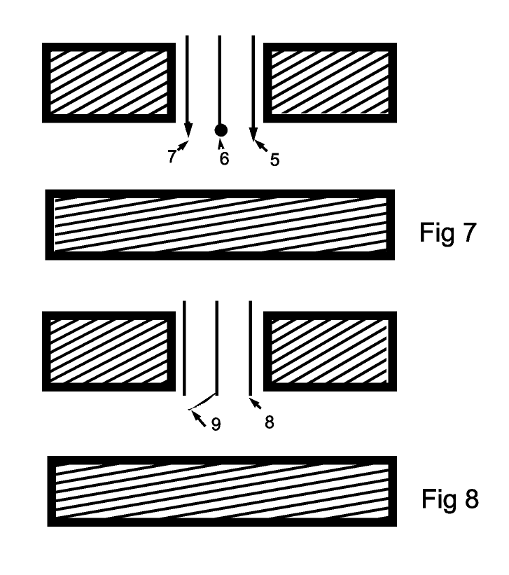

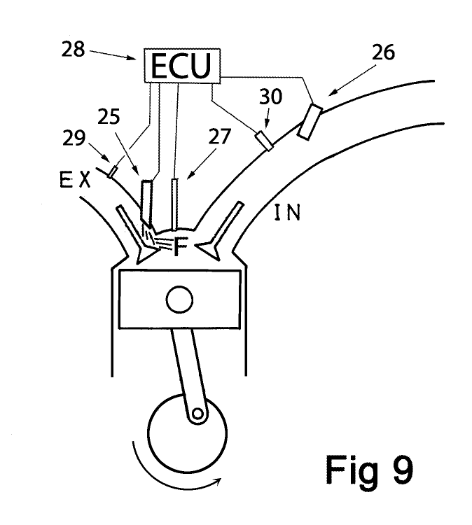

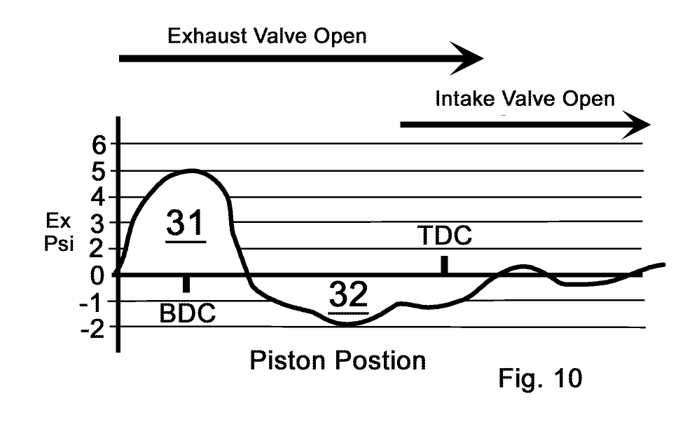

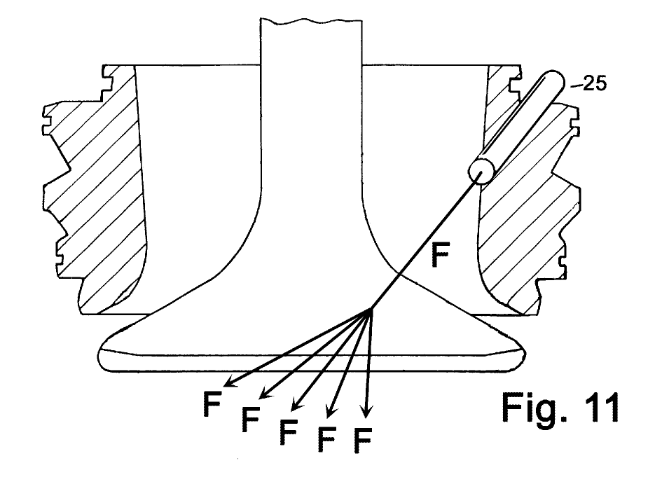

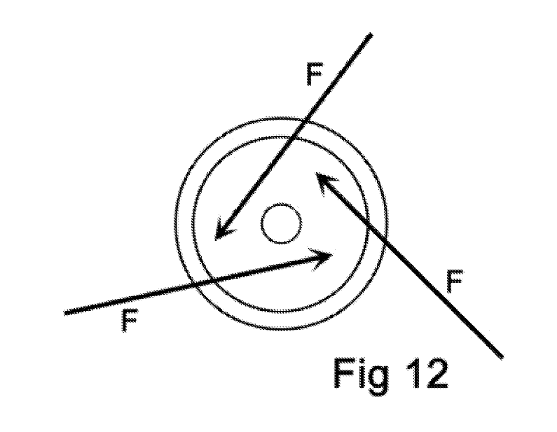

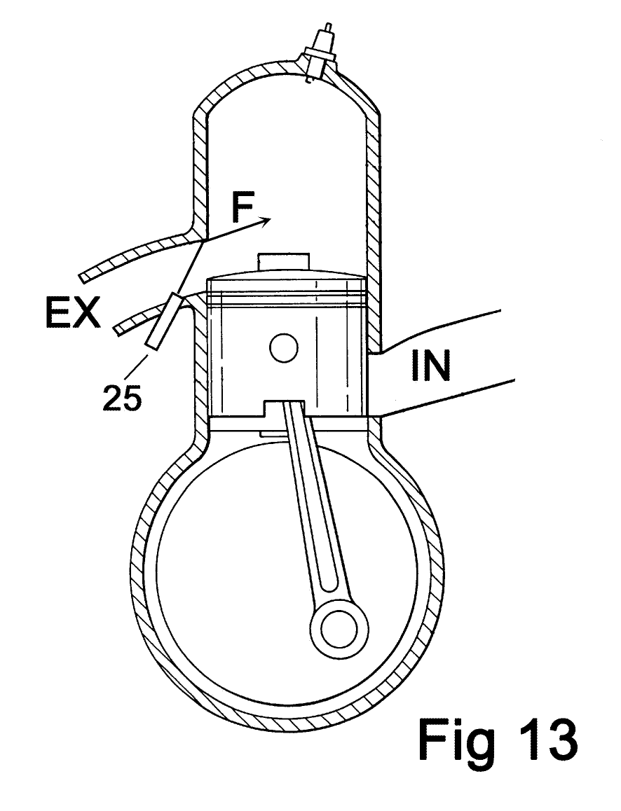

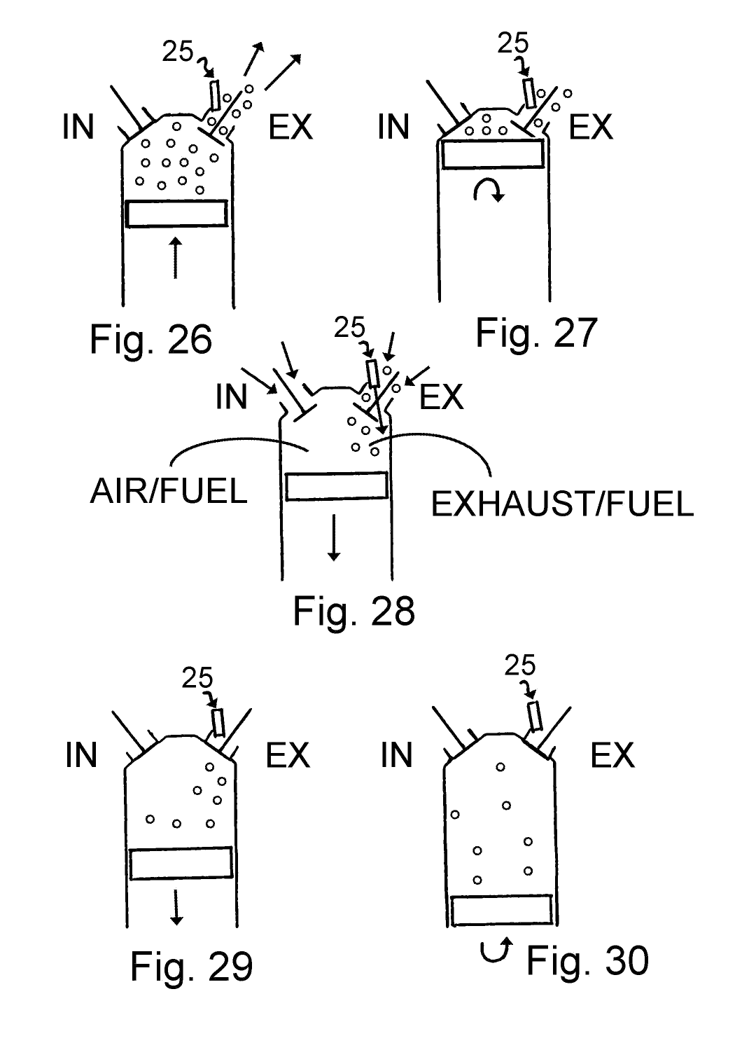

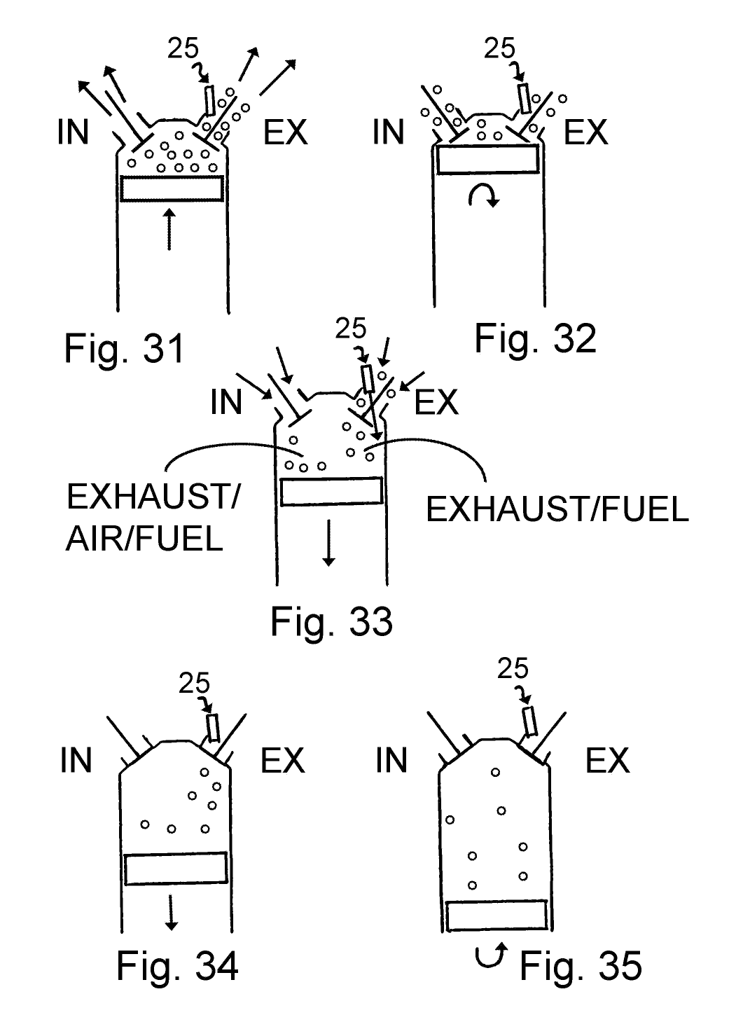

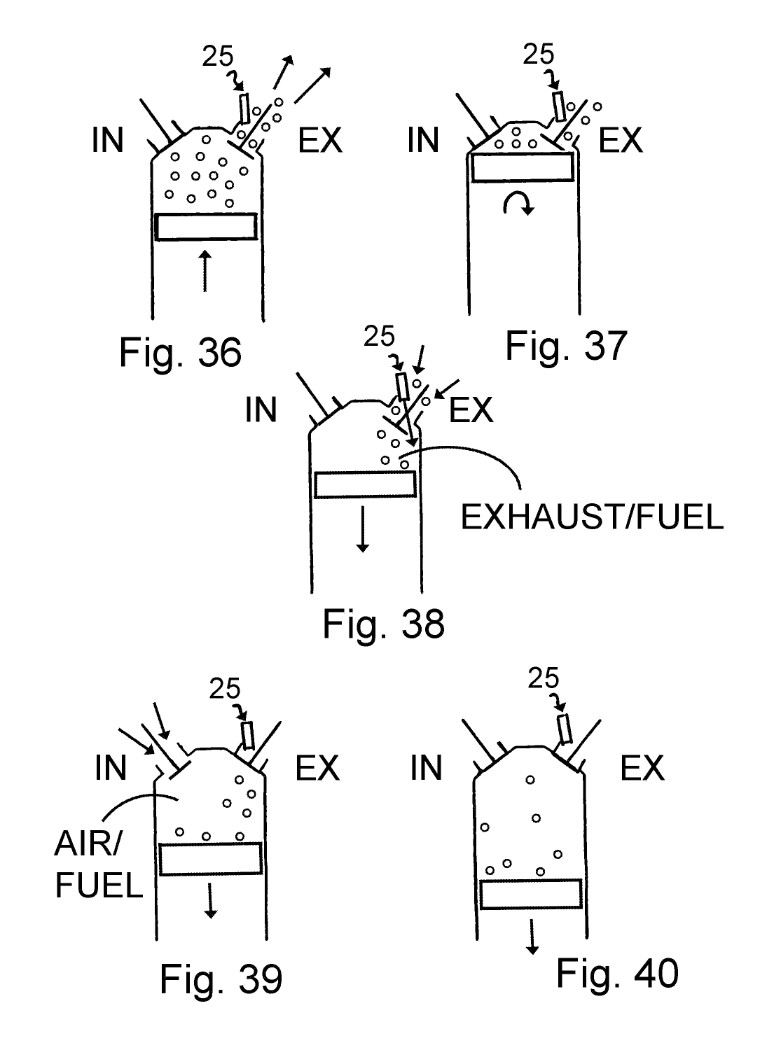

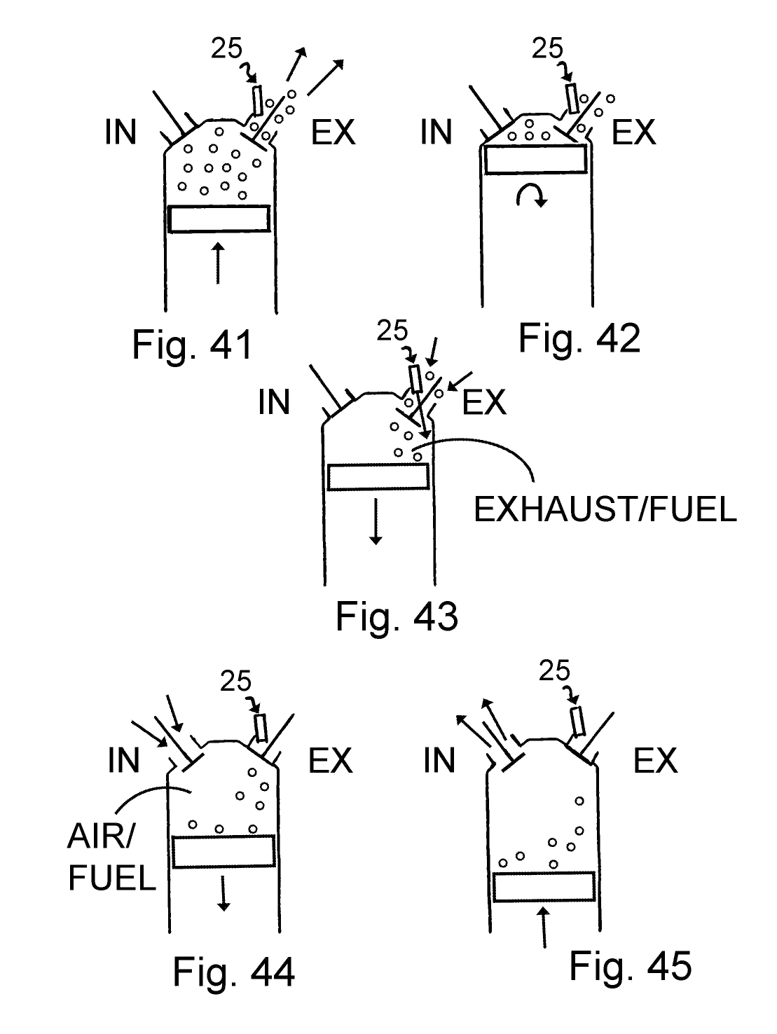

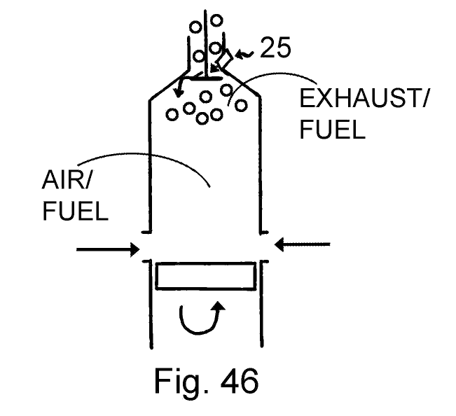

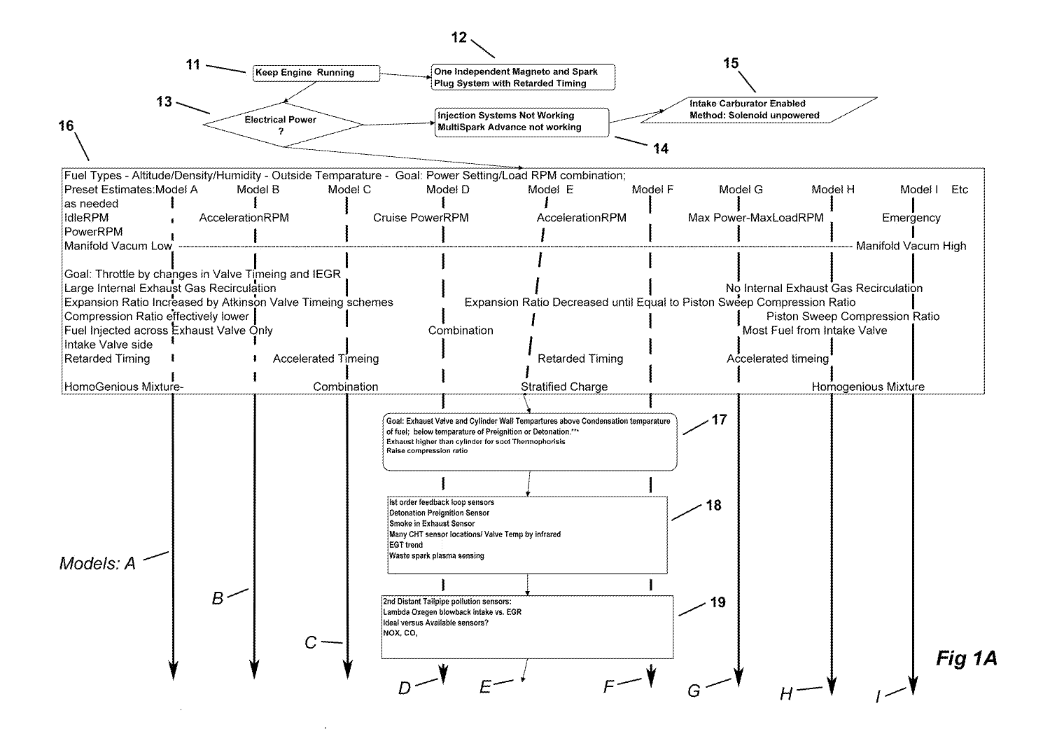

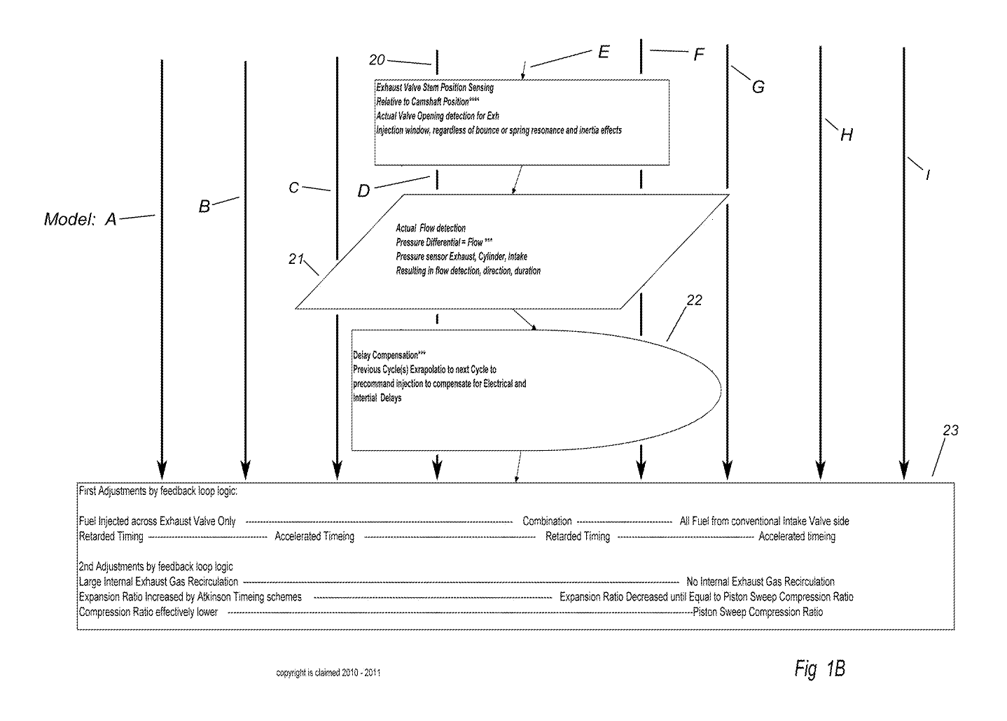

FIG. 1A and FIG. 1B A horizontal flow chart, table and diagram on 2 pages connected top to bottom with the continuation of 9 arrows labeled Models A thru I, which describes the embodiment of operation of one or more engines.

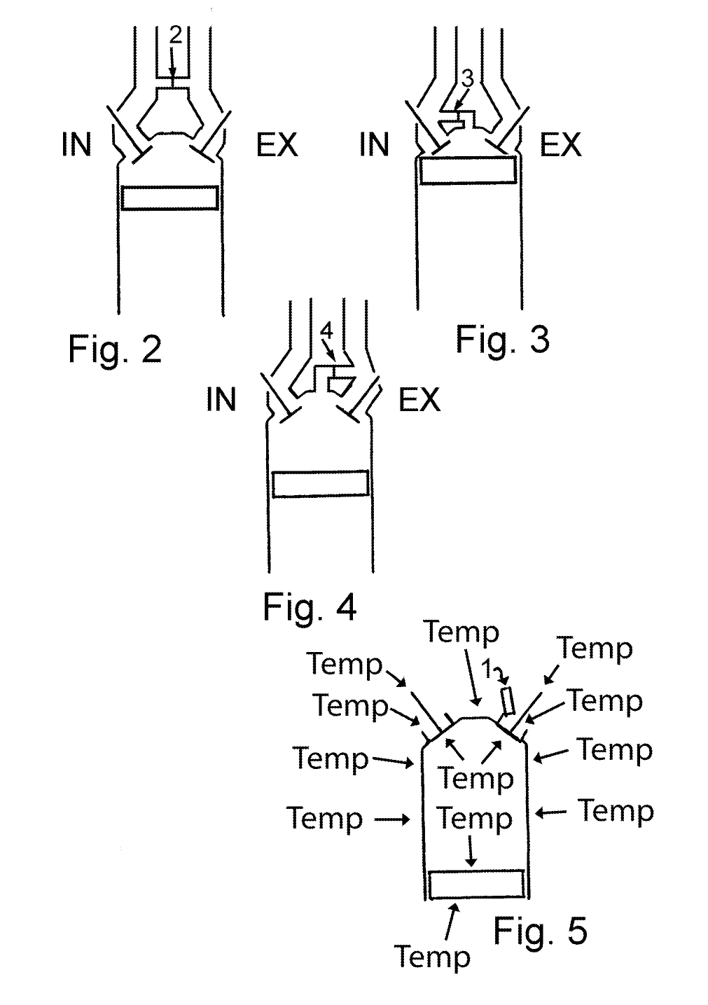

FIG. 2 A pressure differential sensor or sensors placed in a connection between the intake and exhaust tracts near the cylinder of an engine.

FIG. 3 A pressure difference sensor or sensors placed in a connection between the intake tract and the cylinder of an engine.

FIG. 4 A pressure difference sensor or sensors placed in a connection between the exhaust tract and the cylinder of an engine.

FIG. 5 A cylinder of an engine where the embodiments of Temperature sensing in and around the engine.

FIG. 6 A diagrammatic sectional view of an exhaust tract with an embodiment of a sensor of flow in the tract.

FIG. 7 A diagrammatic sectional view of an exhaust tract with an embodiment of a sensor of flow in the tract.

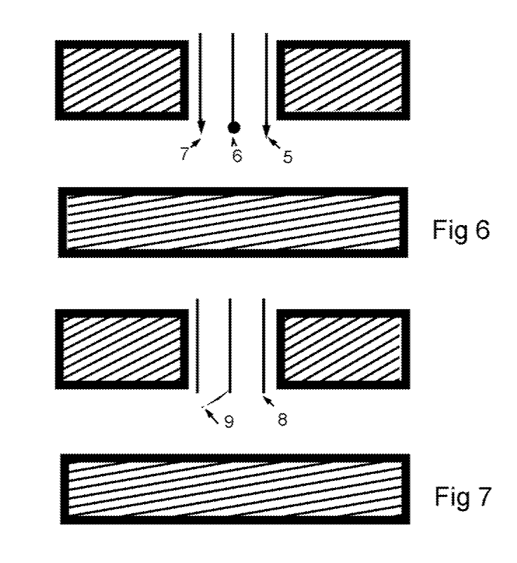

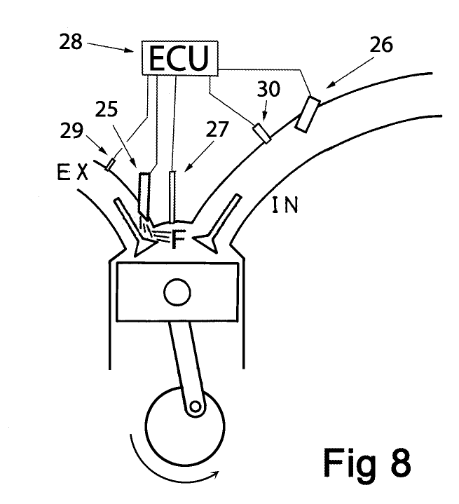

FIG. 8 Shows a System Schematic.

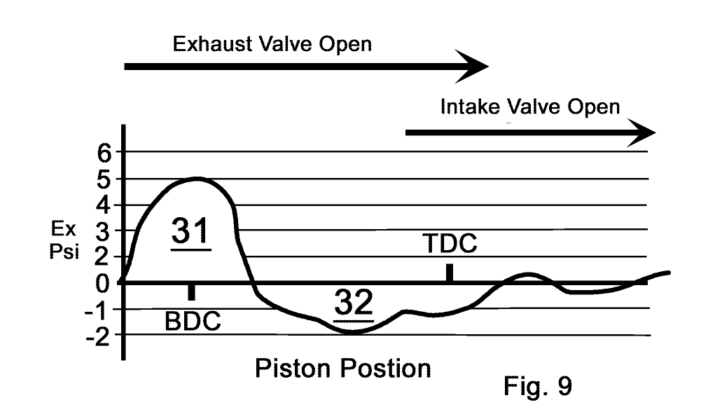

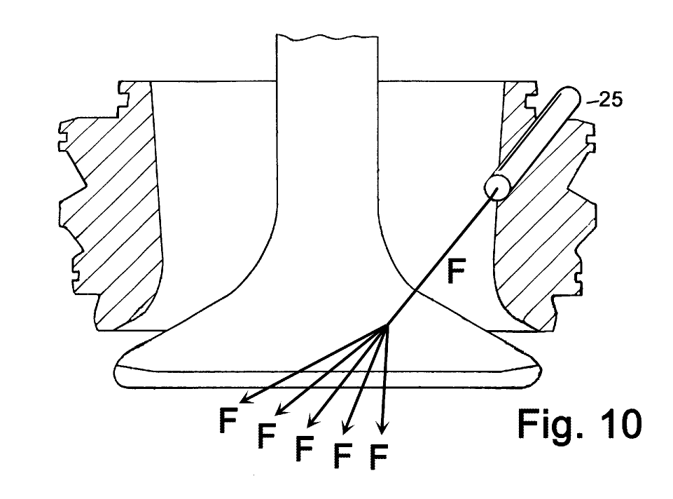

FIG. 9 Shows An example exhaust tract pressure map for a four stroke poppet valve engine is shown as an example in graph FIG. 10 (2).

FIG. 10 Shows an embodiment of deflecting solid streams of fuel (F) (or water) onto the exhaust valves.

FIG. 11 Shows a view of an exhaust poppet valve from above showing an embodiment with three solid stream fuel (F) injection streams deflected off of evenly distributed points of the valve.

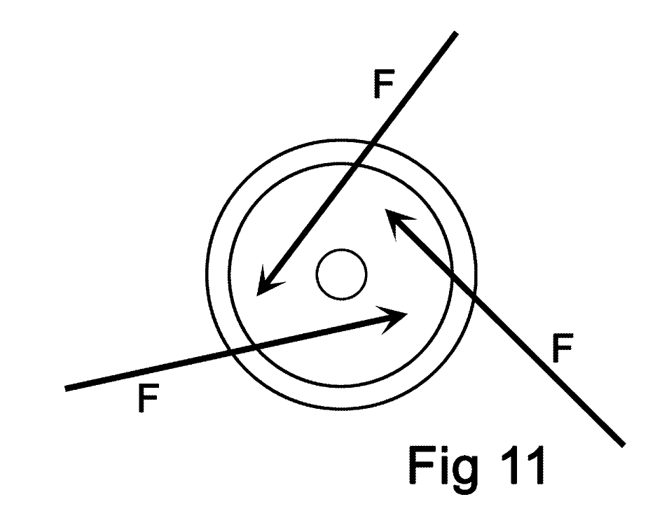

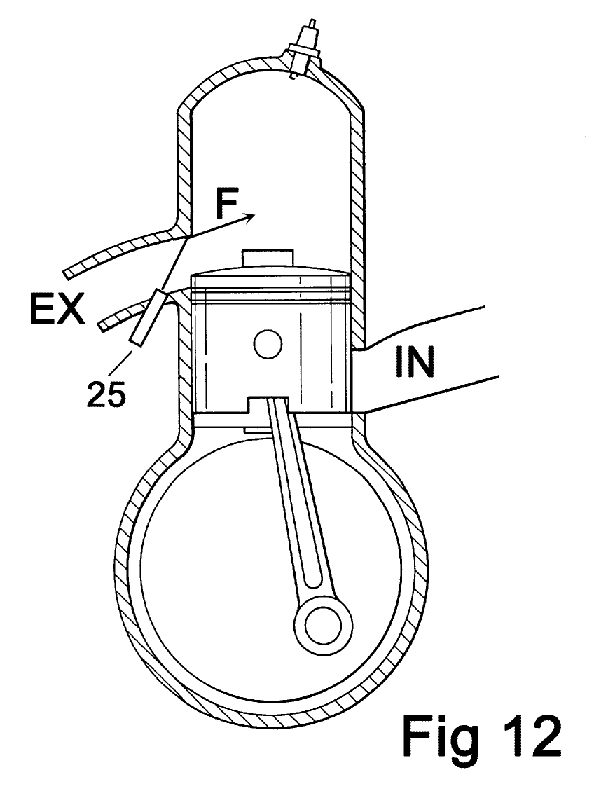

FIG. 12 illustrates an embodiment of one or more solid stream or non-atomizing fuel injector's 1 injections are deflected against the exhaust tract edge of a piston operated cylinder exhaust valve port and said stream (F) is deflected into said combustion chamber and or cylinder of a two stroke engine.

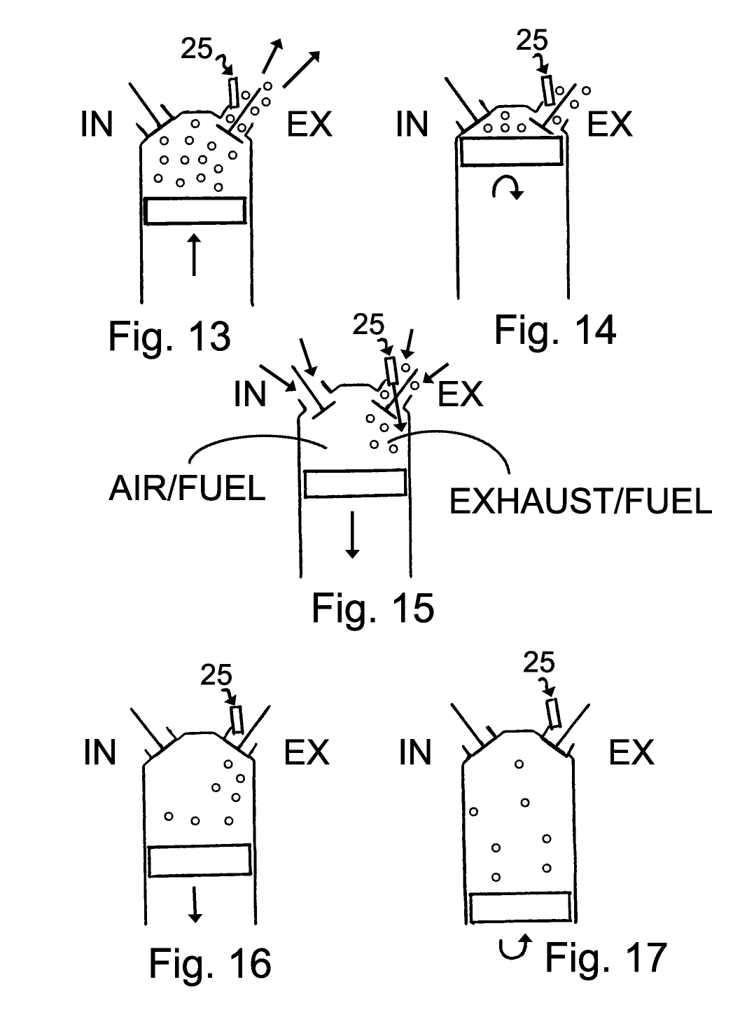

FIG. 13 thru FIG. 17 disclose a 4 stroke poppet valved engine with occurrences in consecutive sequence,

FIG. 13 Near end of Exhaust upstroke, an Intake valve is closed, an Exhaust valve is open, Exhaust gases are driven out said exhaust valve,

FIG. 14 Exhaust Top Dead Center, only said Exhaust valve is open and said Exhaust gases are present in the near areas of an Exhaust tract,

FIG. 15 During Intake downstroke, Inlet and Exhaust valves are open, Fuel has been injected 1 thru said exhaust valve, Fuel could be injected through the intake, (Inlet valve Air+Fuel at mixture ratio of zero to richer than Stoichiometric of its own starting gases or the future total mixture ratio of the whole cylinder)+(Exhaust valve Exhaust Regurgitation+Fuel at mixture ratio of zero to richer than Stoichiometric of its own starting gases or the future total mixture ratio of the whole cylinder)=Control and Optimization of length of time, temperature, and pressure of future burning,

FIG. 16 During Intake downstroke, Inlet and Exhaust valves are closed. An Increase in Expansion Ratio begins by ending further Inhalation at a cylinder volume less than the full usable cylinder volume which will be used during the following combustion downstroke.

FIG. 17 Bottom Dead Center, Intake downstroke stroke changes to upward Compression stroke.

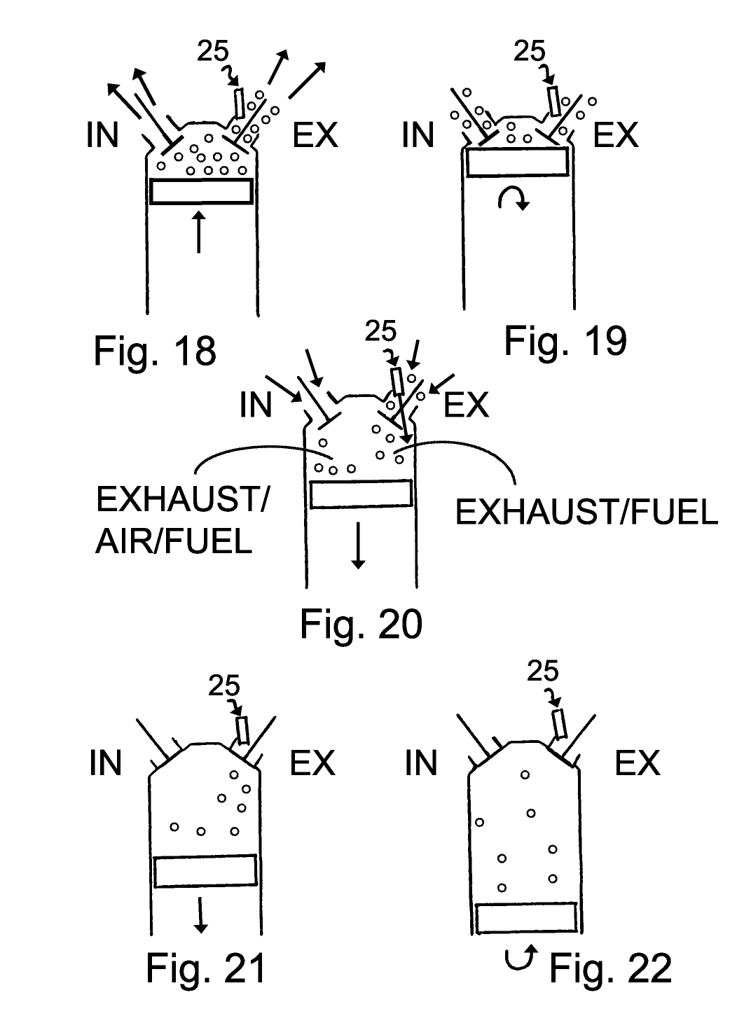

FIG. 18 thru FIG. 22 disclose a 4 stroke poppet valved engine with occurrences in consecutive sequence,

FIG. 18 Near end of Exhaust upstroke, an Inlet valve opens and an Exhaust valve is open, Exhaust gases are driven into Intake and Exhaust tracts, (In a super charged engine the exhaust valve could be closed to force Exhaust gases against the supercharger into the Intake tract, or to control the exhaust gases driven into the Intake tract)

FIG. 19 Exhaust Top Dead Center, valve overlap condition, both valves open and said Exhaust gases are present in the near areas of the Intake and Exhaust tracts,

FIG. 20 During Intake downstroke, Inlet and Exhaust valves open. Fuel has been injected 1 thru said Exhaust valve, Fuel could be injected through the said Intake valve, ((Inlet valve Exhaust Regurgitation+Fuel at mixture ratio of zero to richer than Stoichiometric of its own starting gases or the future total mixture ratio of the whole cylinder)+(Intake Air+Fuel at mixture ratio of zero to richer than Stoichiometric of its own starting gases or the future total mixture ratio of the whole cylinder))+(Exhaust valve Exhaust Regurgitation+Fuel at mixture ratio of zero to richer than Stoichiometric of its own starting gases or the future total mixture ratio of the whole cylinder)=Control and Optimization of length of time, temperature, and pressure of future burning,

FIG. 21 During Intake downstroke, said Inlet and Exhaust valves are closed, An Increase in Expansion Ratio begins by ending further Inhalation at a cylinder volume less than the full usable cylinder volume which will be used during the following combustion downstroke,

FIG. 22 Bottom Dead Center, Intake downstroke stroke changes to upward Compression stroke.

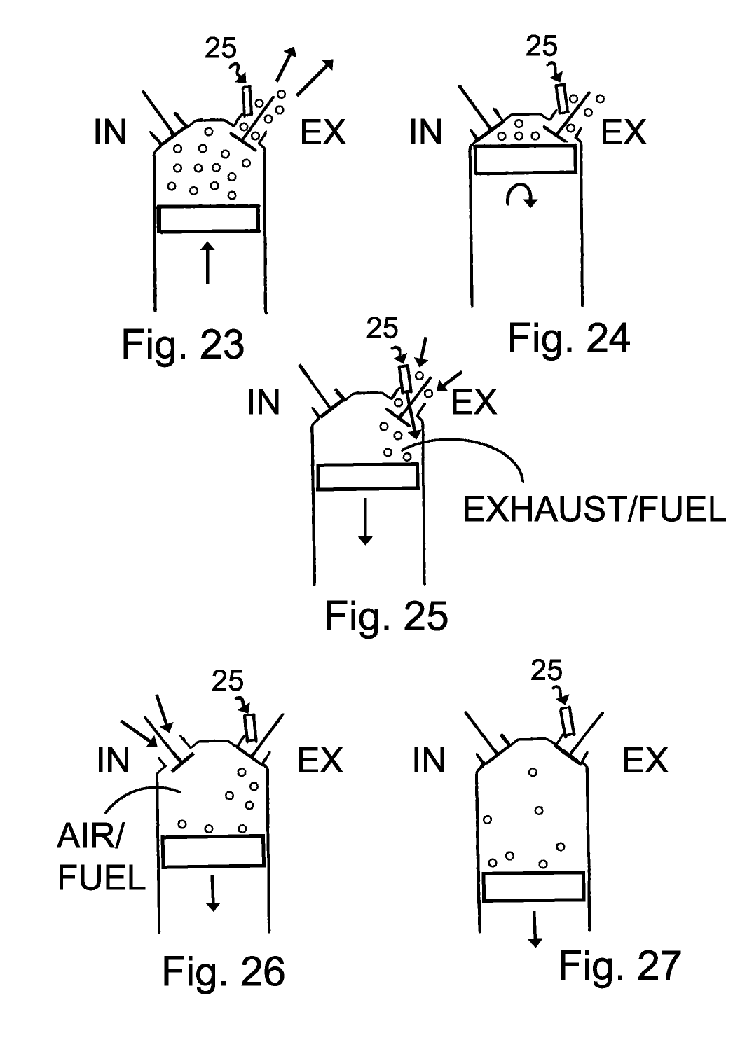

FIG. 23 thru FIG. 27 disclose a 4 stroke poppet valved engine with occurrences in consecutive sequence,

FIG. 23 Near end of Exhaust upstroke, an Intake valve is closed, an Exhaust valve is open, Exhaust gases are driven thru said Exhaust valve,

FIG. 24 Exhaust Top Dead Center, only the Exhaust valve is open and said Exhaust gases are present in the near areas of an Exhaust tract,

FIG. 25 During Intake downstroke, Only said Exhaust valves are open, Fuel has been injected 1 thru said Exhaust valve, (Exhaust valve Exhaust Regurgitation+Fuel at mixture ratio of zero to richer than Stoichiometric of its own starting gases or the future total mixture ratio of the whole cylinder)+

FIG. 26 During Intake downstroke, Only said Inlet valves are open. Fuel could be injected through the said Intake valve, (Intake Air+Fuel at mixture ratio of zero to richer than Stoichiometric of its own starting gases or the future total mixture ratio of the whole cylinder)=Control and Optimization of length of time, temperature, and pressure of future burning,

FIG. 27 During Intake downstroke, Inlet and Exhaust valves are closed, An Increase in Expansion Ratio begins by ending further Inhalation at a cylinder volume less than the full usable cylinder volume which will be used during the following combustion downstroke.

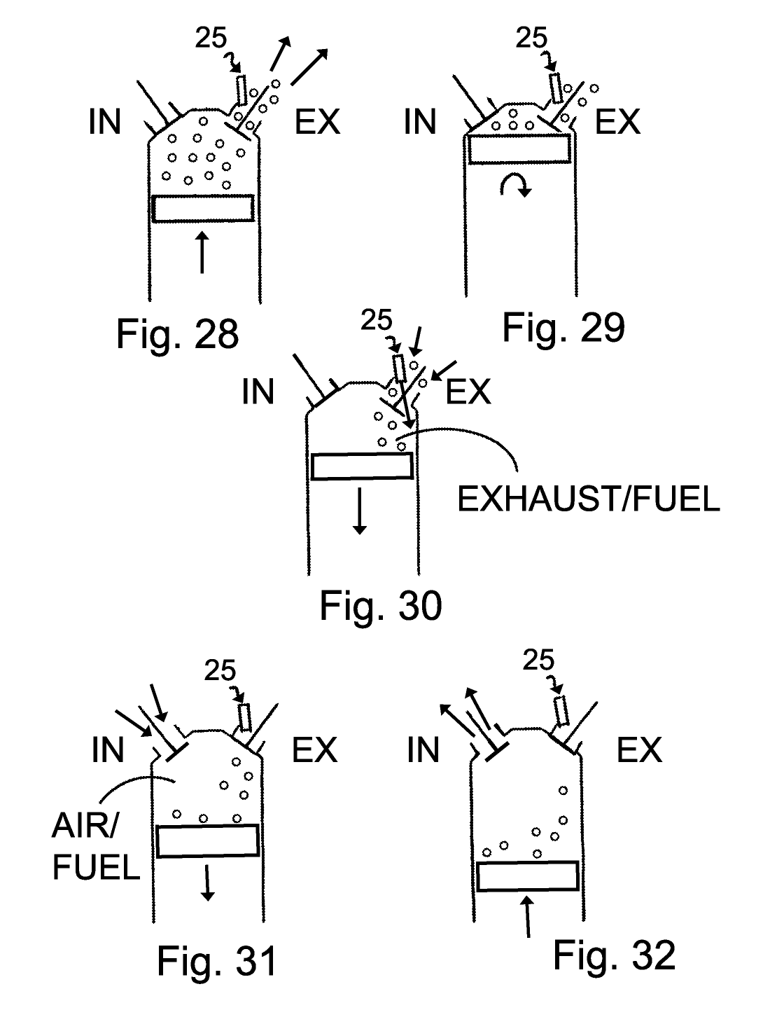

FIG. 28 thru FIG. 32 disclose a 4 stroke poppet valved engine with occurrences in consecutive sequence,

FIG. 28 Near end of Exhaust upstroke, an Intake valve is closed, an Exhaust valve is open, Exhaust gases are driven out exhaust valve,

FIG. 29 Exhaust Top Dead Center, only said Exhaust valve is open and Exhaust gases are present in the near areas of an Exhaust tract,

FIG. 30 During Intake downstroke, Only said Exhaust valves are open. Fuel has been injected thru said Exhaust valve, (Exhaust valve Exhaust Regurgitation+Fuel at mixture ratio of zero to richer than Stoichiometric of its own starting gases or the future total mixture ratio of the whole cylinder)+FIG. 31 During Intake downstroke, only Inlet valves are open, Fuel could be injected through the Intake, (Intake Air+Fuel at mixture ratio of zero to richer than Stoichiometric of its own starting gases or the future total mixture ratio of the whole cylinder)=Control and Optimization of length of time, temperature, and pressure of future burning,

FIG. 32 During the Compression upstroke the intake valve is open to allow some of the cylinder gases to be sent out of the cylinder back into the intake tract, An Increase in Expansion Ratio occurs by reducing the Inhalation cylinder volume to less than the full usable cylinder volume which will be used during the following combustion downstroke.

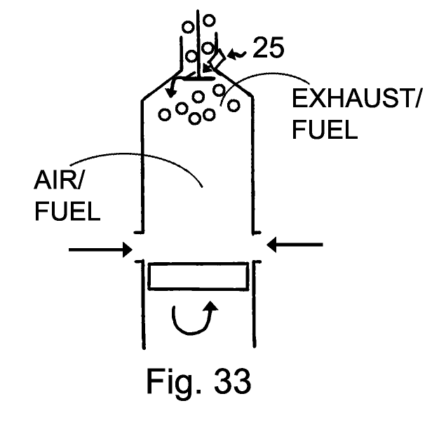

FIG. 33 is a Supercharged Two Stroke Engine with a poppet exhaust valve and a cylinder piston port valve intake, Fuel is injected against the flow of exhaust, (Intake Air+Fuel at mixture ratio of zero to richer than Stoichiometric of its own starting gases or the future total mixture ratio of the whole cylinder)+(Exhaust valve Exhaust Regurgitation+Fuel at mixture ratio of zero to richer than Stoichiometric of its own starting gases or the future total mixture ratio of the whole cylinder)=Control and Optimization of length of time, temperature, and pressure of future burning.

### ELEMENTS LETTERS

### Temperature Location (TEMP)

### Model (A)

### Model (B)

### Model (C)

### Model (D)

### Model (E)

### Model (F)

### Model (G)

### Model (H)

### Model (I)

### Fuel (F)

### Engine Control Unit (ECU)

Intake tract (IN)
Exhaust tract (EX)

### REFERENCE NUMERALS

1 Fuel injectors in the exhaust port.
2 A pressure differential sensor or sensors
3 A pressure differential sensor or sensors
4 A pressure differential sensor or sensors
5 Pointed sensor probe
6 Ball sensor probe
7 Pointed sensor probe
8 contact
9 flow moved element
11 Flow Chart Box 1
12 Flow Chart Box 2
13 Flow Chart Box 3
14 Flow Chart Box 4
15 Flow Chart Box 5
16 Flow Chart Box 6
17 Flow Chart Box 7
18 Flow Chart Box 8
19 Flow Chart Box 9
20 Flow Chart Box 10
21 Flow Chart Box 11
22 Flow Chart Box 12
23 Flow Chart Box 13
25 Fuel injectors in the exhaust port.
26 Fuel injector 2 (FIG. 1) on the conventional intake.
27 Pressure sensors combustion chamber.
28 Engine Control Unit (ECU).
29 Pressure sensors in the exhaust tract.
30 Pressure sensors intake tract.
31 (7.) Positive pressure in the exhaust piping.
32 (8.) Negative pressure in the exhaust piping.

### DESCRIPTION

An engine with features, sensors and methods of control related to fuel injected from the exhaust side of the exhaust valve into the combustion chamber and cylinder.

Box 10 of FIG. 1A is a group of Preset Estimates 16, Models A thru I. 9 models of engine operating condition scenarios. Other embodiments consisting of less or more models could exist.

Many of the engine model parameters consist of ranges limited to those rationally possible and desirable in the named engine model operating scenario 23. This is important to correct for the unreliability of sensors, wiring, algorithms etc. that might product wrong destructive results. Wrong inputs would exceed the range of rational inputs the model operating scenario and therefore only the edge of the range closest to the wrong input would be used, as further wrong input would not be acted upon.

This concept of range limiting can also be applied to the inputs and outputs of the model and internal calculations within the model. Embodiments of descriptive names of models in ascending power output and ascending RPM are found in Box 10 FIG. 1A: “Idle RPM Model A, Acceleration RPM B, Cruise Power RPM C, Acceleration RPM D, Max Power-MaxLoadRPM E, Emergency I”.

Listed first in Box 10 of FIG. 1A are some of the inputs that help to decide which model scenario of engine operation should be occurring at that moment, often from a human driver pushing down the right foot, with the listed “Fuel Types—Altitude/Density/Humidity—Outside Temperature—Goal: Power Setting/Load RPM combinations. Thus each of the Models A thru I might have a range of submodels corrected for different fuel types and qualities and other conditions.

The above procedure could be circumvented by direct selection of the model scenario to be implemented that can still occur as sensors malfunction, by cross checking for rationality or ultimately selecting the operating model best associated with the requesting input to the system. This cross checking could be as simple as the stepwise position of the throttle, with the ECU discarding subtle management for more direct and fewer levels of control as sensor inputs become out of boundary or fail cross checking of redundant sensors. In existing systems such as commercial aircraft, the failure of a sensor can cause all or part of control systems to shut down, leaving the operator not knowing who or what is flying the airplane or what is the source of problems. This is particularly confusing if a manual style throttle does not physically and visually move when controlled by an automatic system. The goals and benefits of multi model operating scenario based control are for human interface cognition as well as physics efficiency and graceful degradation of failure modes.

In other embodiments the models could be directly selected by name, or with a button with the name label or symbol describing the mode. In some applications such as a fixed wing aircraft the mode input could be the only method of engine control and matched with other model settings for other non-engine aspects of the vehicle mode. In other embodiments the model buttons are an override for a throttle quadrant or right foot pedal input, or the conventional throttle input only acts within the selected mode range.

Operation of a generator, or a fixed wing aircraft, in person or by remote control can be very amenable to such low operator workload control of an engine or engines operation by overt and direct multi model operating scenario selection.

Method of solenoid or actuator unpowering as in 15 of FIG. 1A, often use the assistance of a mechanical spring which brings critical engine devices into position for viable operation without electricity. An embodiment of solenoid or actuator unpowering would be usefully applied to the mechanical movement of valve timing adjustability which is moved to a fixed compromise position after failure of controlling systems. Similar apparatus could be applied to variable compression devices that might coexist to compensate for the effects of variable valve timing such as Atkinson timing. Such a compromise fail safe valve and compression ratio position would be included in an embodiment of graceful degradation, where the engine could endure a full failure of all electronically controlled functions. Some reversion to Mechanical throttling by operator control of an engine choking in mechanism and a second set of spark plugs powered by a separate electrical system in turn powered by a generator 12 that can self start when the engine shaft is rotated, by windmilling a propeller or pushing a wheeled vehicle down a hill is a desirable embodiment.

Because of physical delays, the movement of previous combustion cycles and estimates of physical lags based on measurements would allow compensating to create a prospective signal for the next combustion cycle.

There are so many non-linear interdependent variables in engine parameters that a unified model involving innovations may be beyond a single sentence claim to express, be it controlled by elaborate mechanical systems or thousands or millions of lines of computer code. Thus it may be described as subset relations where other variables may be held static or ignored or assumed to be in some optimized state. Mpep 2173.05(s) ‘necessity of reference to figures or tables, Mpep 608.01(m) ‘reference characters must be enclosed with parenthesis.’

I claim:

1. A method of optimizing the operating of a supercharged or naturally aspirated internal combustion piston engine with separate intake and exhaust valves with substantially and continuously separate exhaust and intake tracts leading separately to the atmosphere, whose exhaust tract is of a length and continuity where no substantial fresh air would flow backwards down said exhaust tract into the combustion chamber as a result of common pressure waves, comprising:
a) injecting forcibly a substance comprising either fuel or water or both fuel and water from within said exhaust tract into said combustion chamber thru said open exhaust valve port into said combustion chamber and cylinder by one or more fuel injector's injections from a distance from said exhaust valve equal to less than 7 or 5 or 2 or 1 diameters of the circle equivalent two dimensional sectional area of said exhaust valve tract and face opening junction, into said combustion chamber and or cylinder for the next cycle of combustion thru said exhaust valve of said combustion chamber or said cylinder,
b) timing said injections so that said fuel will arrive and pass through said exhaust valve while said exhaust valve is open,
c) optimizing variation of air fuel ratios and total amounts of fuel and or types of fuel shared between intake and exhaust injections; optimizing for the difference in heating of the fuel between said intake and said exhaust injection sources, optimizing for the longer overall mixing time and residency time and hotter and different combustion gases available to the exhaust injected fuel while said exhaust valve is open in comparison to the intake injection.
d) throttling the engine by valve timing is varied during engine operation:
d1) using more regurgitated exhaust gas supplied from said exhaust valves and fuel supplied from said exhaust valves,
d2) using less amounts of air from said intake valves and less or no fuel from said intake valves,
d3) using less or no fuel from direct injectors,
e) Maintaining chamber side exhaust valve surface temperatures below the temperature of preignition of detonation and the interior of the cylinder surfaces and the combustion cylinder side interior side of the valves above the temperature that would induce condensation of the fuel in the cylinder mixture during the inhalation phase of the engine cycle,
f) For maximum power and efficiency within the constraints of emissions regulations, raising compression ratio of engine of fixed design or dynamically in variable compression designs engines until the exhaust valve is again within an operating temperature range near the limits of structural metal limits and the detonation and preignition limits of the engine design,
g) methods of optimization also comprising using sensors and logic comprising the diagram (FIG. 1A and FIG. 1B)

2. The method of claim 1 further comprising maintaining the cylinder side and exhaust side exhaust valve surface temperatures above the temperatures of the interior of the cylinder surfaces during the inhalation phase of the engine cycle, to encourage soot particles to flow from the exhaust valve to the cooler cylinder for reburning.

3. The method of claim 1 further comprising The engine of claim 1 wherein optimized by using the knock sensing, exhaust gas temperature, cylinder head temperature, oxygen sensor, air mass sensor, intake temperature and pressure sensors in said exhaust tract valve area, said combustion chamber and said intake.

4. The method of claim 1 further comprising optimizing by sensing of temperature in many locations of the engine (FIG. 5).

5. The method of claim 1 further comprising sensing directly the exhaust valve stem position measuring actual valve position including bounces and resonances to signal when the valve is open and with more accuracy than the crankshaft and camshaft position
a) utilizing magnetic field effects such as a hall sensor per valve stem.
b) sensing by optical measurements the spring/camshaft end along the potential valve path, where the valve shaft tip blocks or fails to completely block, or blocks to a varying amount, the optical sensor, at the anticipated moment relative to known crankshaft and camshaft position.

6. The method of claim 1 further comprising in cylinder means such as sparkplug or separate sensors of post combustion plasma sensing or gas temperature or other means whereby sensing of combustion results is without distortion by recirculated exhaust gases.

7. The method of claim 1 further comprising sensing oxygen in the intake tracts and or the exhaust tract and combining with a valve timing pushing the mixture of intake and recirculated exhaust gases before temporarily into the intake tract or the exhaust tract to allow detection of the pre combustion conditions reflective of what is occurring in the combustion chamber,

8. The method of claim 1 further comprising inferring from a memory of recent conditions allowing the exhaust gas temperature to know where it has been before changing engine inputs, inferring what side of Stoichiometric the engine is operating, examining a range of fuel amounts to find a peak exhaust temperature representing Stoichiometric confirming what side of Stoichiometric the engine is in and therefore what a change in exhaust temperature signals.

9. The method of claim 1 further comprising sensing cylinder head temperature.

10. The method of claim 1 further comprising sensing of carbon soot particles in the exhaust stream.

11. The method of claim 1 further comprising sensing optical smoke density as soot information.

12. The method of claim 1 further comprising sensing valve temperature using optical sensors as a means for measuring the thermal expansion of the valve at the moment the valve is closed, measuring the loss of valve to camshaft lobe's clearance gap at the camshaft lobe's lowest points or as a measurement from the engine body.

13. The method of claim 1 further comprising sensing valve temperature using a highly conductive substance is imbedded in the valve that reveals temperature rapidly from the valve petal to the valve spring end where temperature can be optically detected.

14. The method of claim 1 further comprising sensing valve temperature using the whole valve as a thermocouple with the output powering an electrically powered emitter where it can be read in the camshaft or rocker gallery.

15. The method of claim 1 further comprising sensing valve temperature using a valve embedded temperature sensor which conducts the information electrically to the valve stem where it can be read in the camshaft or rocker gallery.

16. The method of claim 1 further comprising sensing valve temperature using a valve embedded temperature sensor powered by a remote radio frequency transmitter to produce a radio signal of the valve temperatures and a remote radio frequency receiver receiving the temperature information.

17. The method of claim 1 further comprising sensing valve temperature directing infrared sensors at the valve from the inside of the exhaust tract.

18. The method of claim 1 further comprising sensing the pressure differential by a sensor placed in pipe between intake and exhaust ports.

19. The method of claim 1 further comprising sensing the pressure differential by a sensor placed in pipe between a cylinder and exhaust ports.

20. The method of claim 1 further comprising sensing the pressure differential by a sensor placed in pipe between a cylinder and intake ports.

21. The method of claim 1 further comprising sensing flow in the pipe flexible yarn, strand, chain or mechanical flags in one location or many locations around the circumference of the exhaust pipe, and on each side of a sandwich of electrical insulation holding the cilia, is conductive materiel that contacts the cilia to create a change in resistance, plasma, radio frequency or capacitance or other means that forms a the signal that indicates flow direction.

22. The method of claim 1 further comprising sensing flow in the pipe using 3 electrodes, the center electrode producing plasma, radio frequency or capacitance or other means and the outer electrodes receiving changing amounts of plasma, radio frequency or capacitance or other means to detect the direction of flow within the exhaust tract or the intake tract wherein the electrodes may be sharp and or thin to allow carbon to burn off the sensing tip or the electrodes may be globes.

23. The method of claim 18, 19, 20, 21, or 22 further comprising sensing thru, between or integrated into a gasket.
